(19) United States
(12) Patent Application Publication
(10) Pub. No.: US 2026/0011887 A1
(43) Pub. Date: Jan. 8, 2026

(54) POWER STORAGE CELL AND POWER STORAGE MODULE

(71) Applicant: TOYOTA JIDOSHA KABUSHIKI KAISHA, Toyota-shi Aichi-ken (JP)

(72) Inventors: Masayoshi HAGA, Nagoya-shi Aichi-ken (JP); Kazuki MURAISHI, Toyota-shi Aichi-ken (JP); Shinya ISHIKAWA, Anjo-shi Aichi-ken (JP); Yusuke KINTSU, Miyoshi-shi Aichi-ken (JP); Takumi TANAKA, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/188,619

(22) Filed: Apr. 24, 2025

(30) Foreign Application Priority Data
Jul. 2, 2024 (JP) 2024-106719

(51) Int. Cl. H01M 50/579; H01M 50/172; H01M 50/502; H01M 50/531; H01M 50/548; H01M 50/586

(52) U.S. Cl. CPC H01M 50/579; H01M 50/172; H01M 50/502; H01M 50/531; H01M 50/548; H01M 50/586

(57) ABSTRACT

A power storage cell includes a case and a power generating element. The case houses the power generating element, and the case includes a case body and a lid. The lid is provided with an electrode terminal. The electrode terminal includes a first portion, a second portion, and a third portion. The first portion is located outside the case. The third portion is located inside the case. The second portion connects the first portion and the third portion. The third portion is connected to the power generating element. The second portion has a smaller diameter than the first portion and the third portion.

### CROSS-REFERENCE TO RELATED APPLICATION

This application claims priority to Japanese Patent Application No. 2024-106719 filed on Jul. 2, 2024, incorporated herein by reference in its entirety.

### BACKGROUND

### 1. Technical Field

The present disclosure relates to a power storage cell and a power storage module.

### 2. Description of Related Art

Japanese Unexamined Patent Application Publication No. 2022-108655 (J P 2022-108655 A) discloses a secondary battery including an electrode terminal that functions as a fuse.

### SUMMARY

An electrode terminal may be provided on a side surface of a power storage cell. In this case, when an external force, such as an impact, is applied to the electrode terminal and the electrode terminal is damaged, a short circuit may occur.

An object of the present disclosure is to suppress the occurrence of short circuits.

A technical configuration and effects of the present disclosure will be described below. Note that an effect mechanism of the present disclosure includes speculation. The effect mechanism does not limit the technical scope of the present disclosure.

(1) A power storage cell includes a case, and a power generating element.
The case houses the power generating element, and
the case includes a case body and a lid.
The lid is provided with an electrode terminal.
The electrode terminal includes a first portion, a second portion, and a third portion.
The first portion is located outside the case.
The third portion is located inside the case.
The second portion connects the first portion and the third portion.
The third portion is connected to the power generating element.
The second portion has a smaller diameter than the first portion and the third portion.

The second portion has a smaller diameter than the first portion and third portion. Therefore, when an external force, such as an impact, is applied to the electrode terminal, the pressure per unit area applied to the second portion is greater than that applied to the first portion and third portion. Accordingly, the second portion is selectively damaged. That is, the second portion functions as an external force suppression portion, thereby cutting off a conductive path within the power storage cell. As a result, it is expected that the occurrence of short circuits will be suppressed.

(2) In the power storage cell according to (1), at least a part of the second portion is located inside the case.

(3) In the power storage cell according to (1) or (2), when an external force is applied to the electrode terminal, the first portion is separated from the second portion.

(4) A power storage module includes a plurality of the power storage cells according to any one of (1) to (3), and a busbar. The busbar connects between the first portions of adjacent ones of the power storage cells.

Hereinafter, one embodiment of the present disclosure (hereinafter may be abbreviated as “the embodiment”) will be described. However, the embodiment does not limit the technical scope of the present disclosure. The embodiment is illustrative in all respects. The embodiment is non-limiting. The technical scope of the present disclosure includes all changes within the meaning and range equivalent to the description of the claims. For example, it is anticipated from the beginning that any configurations may be extracted from the present embodiment and arbitrarily combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram illustrating an example of a power storage cell in an embodiment;

FIG. 1B is a schematic diagram illustrating an example of the power storage cell in the embodiment;

FIG. 2 is a schematic sectional view illustrating an example of the power storage cell in the embodiment;

FIG. 3 is a schematic plan view illustrating an example of an electrode terminal in the embodiment;

FIG. 4 is a schematic plan view illustrating another example of the electrode terminal in the embodiment;

FIG. 5 is a schematic plan view illustrating an example of a vicinity of the electrode terminal in the embodiment;

FIG. 6A is a schematic plan view illustrating an example of a vicinity of the electrode terminal when an external force is applied to the electrode terminal in the embodiment;

FIG. 6B is a schematic plan view illustrating an example of the vicinity of the electrode terminal when the external force is applied to the electrode terminal in the embodiment;

FIG. 7A is a schematic plan view illustrating another example of a vicinity of the electrode terminal when an external force is applied to the electrode terminal in the embodiment;

FIG. 7B is a schematic plan view illustrating the other example of the vicinity of the electrode terminal when the external force is applied to the electrode terminal in the embodiment; and

FIG. 8 is a side view illustrating an example of a power storage module in the embodiment.

### DETAILED DESCRIPTION OF EMBODIMENTS

### Terms and Phrases

“Provide”, “include”, “have”, and variations thereof are open-ended terms. The open-ended terms may or need not include an additional element in addition to a required element. A statement of “consist of” is a closed term. However, even though a configuration is expressed in closed terms, the configuration may contain normally incidental impurities or additional elements irrelevant to the target technique. A statement of “substantially consist of” is a semi-closed term. The semi-closed term allows addition of an element that does not substantially affect the basic and novel characteristics of the target technique.

Expressions such as “may” and “can” are used in the permissive sense of “having the possibility of” rather than in the obligatory sense of “must”.

The geometric terms are not to be construed in a strict sense. Examples of geometric terms include “parallel”, “perpendicular”, and “orthogonal”. For example, directions, angles, distances, and the like may be relatively displaced within a range in which substantially the same or similar functions are obtained. The geometric terms can include tolerances, errors, and the like regarding, for example, designing, working, and manufacturing of products. Dimensional relationships in each drawing may not match actual dimensional relationships. The dimensional relationships of each drawing may be changed to facilitate understanding by the reader. For example, the length, width, thickness, etc. may be changed. A part of the configuration may be omitted.

Elements described in a “singular form” may also include a plural form unless otherwise specified. For example, an electrode terminal may refer to a plurality of electrode terminals (a group of electrode terminals).

“Power storage cell” refers to a rechargeable battery. The power storage cell may be, for example, a lithium ion battery. The power storage cell may include, for example, a liquid electrolyte (electrolytic solution), a gel electrolyte, or a solid electrolyte.

“Electrode” is a general term for a cathode and an anode. Similarly, for example, “electrode terminal” is a general term for a cathode terminal and an anode terminal.

### Power Storage Cell

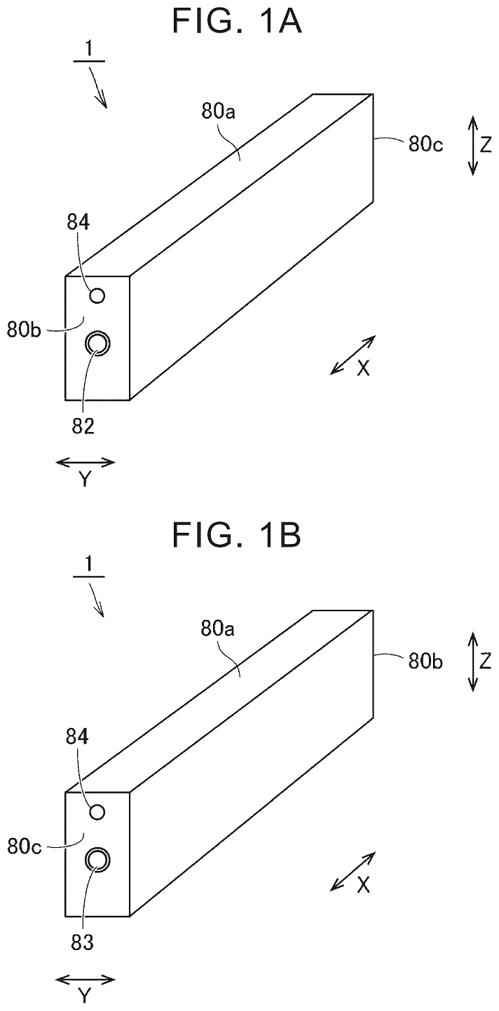

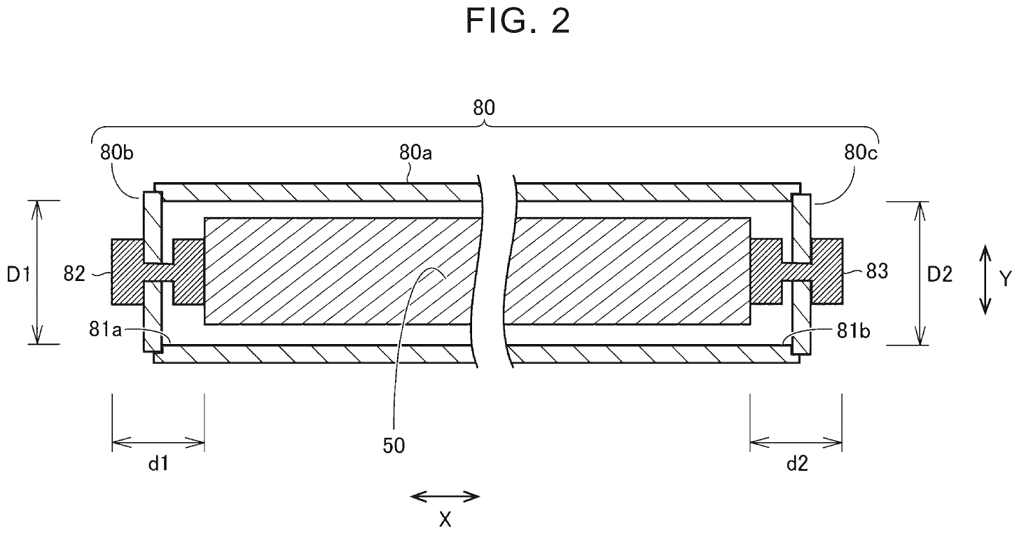

FIGS. 1A and 1B are each a schematic diagram illustrating an example of a power storage cell in an embodiment. FIG. 2 is a schematic sectional view illustrating an example of the power storage cell in the embodiment. A power storage cell 1 includes a case 80 and a power generating element 50. The case 80 houses the power generating element 50. The case 80 includes a case body 80a and a lid.

### Case

The case 80 may be made of metal, for example. The case 80 may contain, for example, aluminum (Al). The case 80 may have a flat-plate-shaped outer shape. The case 80 may be, for example, in the form of a long plate.

### Case Body

The width of the case body 80a is an outer dimension in an X direction. The width of the case body 80a may be, for example, 500 mm or more, 750 mm or more, or 1000 mm or more. The width of the case body 80a may be, for example, 2000 mm or less, 1500 mm or less, or 1250 mm or less. The height of the case body 80a is an outer dimension in a Z direction. The height of the case body 80a may be, for example, 50 mm or more, 75 mm or more, or 100 mm or more. The height of the case body 80a may be, for example, 200 mm or less, 150 mm or less, 125 mm or less, or 100 mm or less. The thickness of the case body 80a is an outer dimension in a Y direction. The thickness of the case body 80a may be, for example, 5 mm or more, 10 mm or more, 15 mm or more, or 20 mm or more. The thickness of the case body 80a may be 30 mm or less, 25 mm or less, 20 mm or less, 15 mm or less, or 10 mm or less. The ratio of width to height may be, for example, from 5 to 20. The ratio of width to thickness may be, for example, from 50 to 200.

The case body 80a has an opening. The case body 80a may have, for example, a first opening 81a and a second opening 81b. That is, the case body 80a may be cylindrical. The case body 80a may be, for example, in the shape of a rectangular tube. The first opening 81a may be located at one end in an axial direction (X direction). The second opening 81b may be located at the other end in the axial direction.

### Lid

The lid closes the opening. The lid may be one or more. The number of the lids corresponds to the number of openings in the case body 80a. The case 80 may include, for example, a first lid 80b and a second lid 80c. For example, the first lid 80b may close the first opening 81a. For example, the second lid 80c may close the second opening 81b. The lid is provided with an electrode terminal. For example, a cathode terminal 82 may be provided on the first lid 80b. For example, the cathode terminal 82 may be electrically isolated from the first lid 80b by an insulating member (not shown). For example, an anode terminal 83 may be provided on the second lid 80c. One lid may have one electrode terminal. One lid may have a plurality of electrode terminals. When one lid has a plurality of electrode terminals, the electrode terminals may have the same polarity or may have opposite polarities. For example, a liquid inlet 84 may be provided in the lid. For example, the liquid inlet 84 may be provided in the first lid 80b. For example, the liquid inlet 84 may be provided in the second lid 80c.

For example, the thickness (d1) of the first lid 80b may be smaller than the shortest diameter (D1) of the first opening 81a. The thickness (d1) of the first lid 80b includes the thickness of the cathode terminal 82. The “shortest diameter” refers to the shortest inner diameter among inner diameters of the opening. For example, a relationship, such as “d1≤0.9×D1”, “d1≤0.8×D1”, “d1≤0.7×D1”, “d1≤0.6×D1”, or “d1≤0.5×D1”, may be satisfied. For example, a relationship, such as “0.1D1≤d1”, “0.2D1≤d1”, “0.3D1≤d1”, “0.4D1≤d1”, or “0.5D1≤d1”, may be satisfied.

The lid is joined to the case body 80a. For example, as shown in FIG. 2, the position of the first lid 80b is adjusted so that the first lid 80b fits into the first opening 81a. For example, the first lid 80b may be joined to the case body 80a by irradiating a laser beam onto a fitting portion between the first lid 80b and the case body 80a.

### Power Generating Element

The power generating element 50 is also called an “electrode body”. The power generating element 50 may include, for example, a cathode, an anode, a separator, and an electrolyte. The power generating element 50 may be, for example, a stacked type or a wound type. The cathode and the anode may be in a sheet form. The cathode may contain, for example, lithium iron phosphate, lithium nickel composite oxide, or the like. The anode may contain, for example, graphite, silicon oxide, silicon, or the like.

### Electrode Terminal

The cathode terminal 82 passes through the first lid 80b. Inside the case 80, the cathode terminal 82 is electrically connected to the cathode (the power generating element 50). The cathode terminal 82 protrudes from the first lid 80b to the outside of the case 80 along the axial direction (X direction).

The cathode terminal 82 may be made of a conductive material (more specifically, a metal). The cathode terminal 82 may be made of, for example, Al or an Al alloy.

The anode terminal 83 passes through the second lid 80c. Inside the case 80, the anode terminal 83 is electrically connected to the anode (the power generating element 50). In FIG. 2, the anode terminal 83 protrudes in the opposite direction to the direction in which the cathode terminal 82 protrudes. In an embodiment, the anode terminal 83 may protrude in the same direction as the cathode terminal 82. In other words, both the cathode terminal 82 and the anode terminal 83 may be disposed on the second lid 80c.

The anode terminal 83 may be made of a conductive material (more specifically, a metal). The anode terminal 83 may be made of, for example, copper (Cu) or a Cu alloy.

In FIGS. 1A and 1B, the position of the anode terminal 83 in the Z direction is the same as the position of the cathode terminal 82 in the Z direction. The position of the anode terminal 83 in the Z direction may be different from the position of the cathode terminal 82 in the Z direction.

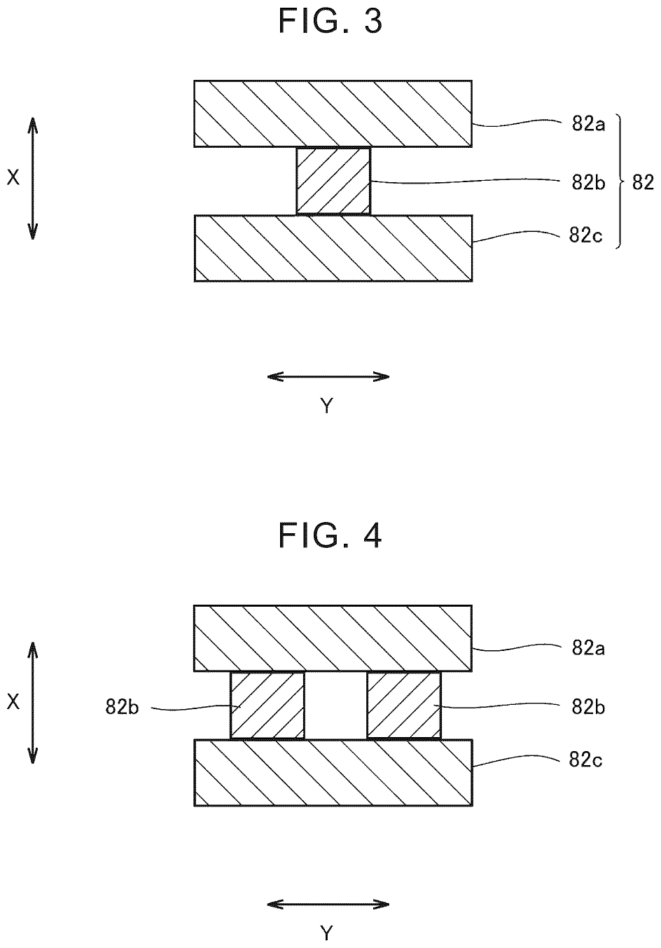

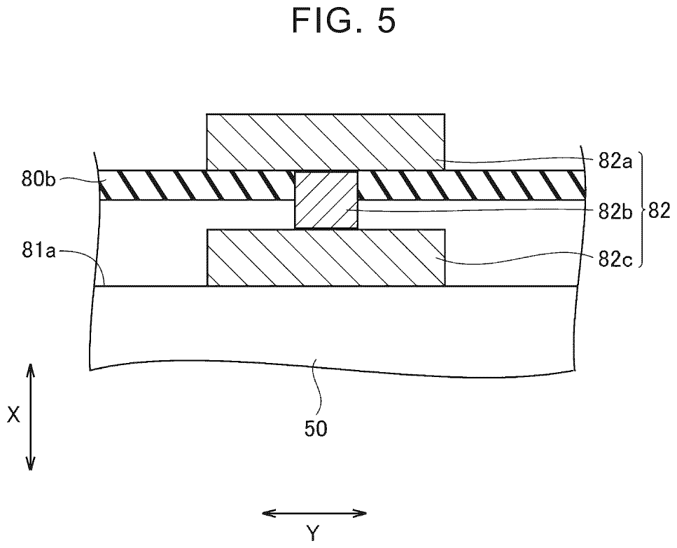

FIG. 3 is a schematic plan view illustrating an example of the electrode terminal in the embodiment. FIG. 4 is a schematic plan view illustrating another example of the electrode terminal in the embodiment. FIG. 5 is a schematic plan view illustrating an example of a vicinity of the electrode terminal in the embodiment. In FIGS. 3 to 5, the cathode terminal 82 is shown. Although not shown, the anode terminal 83 may have a structure similar to that of the cathode terminal 82.

The cathode terminal 82 includes a first portion 82a, a second portion 82b, and a third portion 82c. The third portion 82c is located inside the case 80. The third portion 82c is connected to the power generating element 50. The first portion 82a is located outside the case 80. The first portion 82a includes an end surface of the cathode terminal 82. The end surface of the cathode terminal 82 may be a flat surface or a curved surface.

The second portion 82b is located between the first portion 82a and the third portion 82c. The second portion 82b connects the first portion 82a and the third portion 82c.

The first portion 82a and the second portion 82b may be joined together, and the second portion 82b and the third portion 82c may be joined together. The joining method is not particularly limited, but may be, for example, resistance welding, ultrasonic joining, laser welding, or the like. The first portion 82a and the second portion 82b may have a constricted structure, and the second portion 82b and the third portion 82c may have a constricted structure.

The second portion 82b has a smaller diameter than the first portion 82a and the third portion 82c. Therefore, when an external force, such as an impact, is applied to the cathode terminal 82, the pressure per unit area applied to the second portion 82b is greater than that applied to the first portion 82a and the third portion 82c. Accordingly, the second portion 82b is selectively damaged. That is, the second portion 82b functions as an external force suppression portion, thereby cutting off a conductive path within the power storage cell 1. As a result, it is expected that the occurrence of short circuits will be suppressed.

The second portion 82b may have a constant diameter. The diameter of the second portion 82b may vary in the axial direction of the cathode terminal 82. For example, the second portion 82b may be tapered or inversely tapered in the direction from the third portion 82c toward the first portion 82a.

The first portion 82a and the third portion 82c may have the same diameter. The first portion 82a may have a larger diameter or a smaller diameter than the third portion 82c.

The ratio of the diameter of the second portion 82b to the diameter of the first portion 82a may be, for example, 0.9 or less, 0.8 or less, 0.7 or less, 0.6 or less, or 0.5 or less. The ratio of the diameter of the second portion 82b to the diameter of the first portion 82a may be, for example, 0.1 or more, 0.2 or more, 0.3 or more, 0.4 or more, or 0.5 or more. In a cross section orthogonal to the axial direction of the electrode terminal, when the contour lines of the first portion 82a and the second portion 82b are not circular, the diameter of each portion indicates the maximum diameter.

The ratio of the diameter of the second portion 82b to the diameter of the third portion 82c may be, for example, 0.9 or less, 0.8 or less, 0.7 or less, 0.6 or less, or 0.5 or less. The ratio of the diameter of the second portion 82b to the diameter of the third portion 82c may be, for example, 0.1 or more, 0.2 or more, 0.3 or more, 0.4 or more, or 0.5 or more. In a cross section orthogonal to the axial direction of the electrode terminal, when the contour lines of the third portion 82c and the second portion 82b are not circular, the diameter of each portion indicates the maximum diameter.

At least a part of the second portion 82b may be located inside the case 80. This is expected to further suppress the occurrence of short circuits. In some embodiments, the second portion 82b is located inside the case 80. This is expected to further suppress contact between the second portion 82b and other members and to further suppress the occurrence of short circuits.

The cathode terminal 82 may include a plurality of the second portions 82b. The second portions 82b may have the same diameter or may have different diameters.

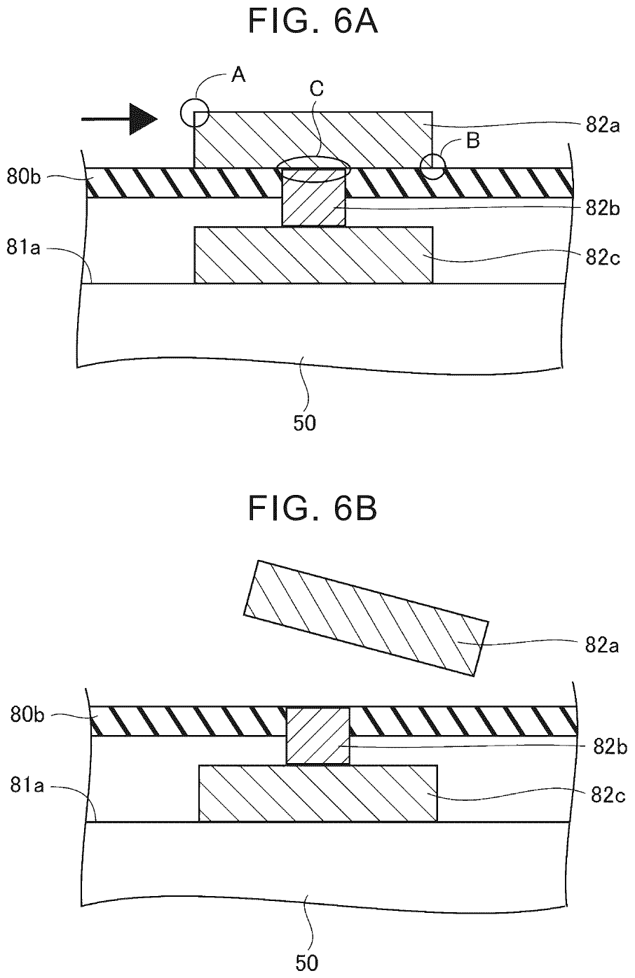

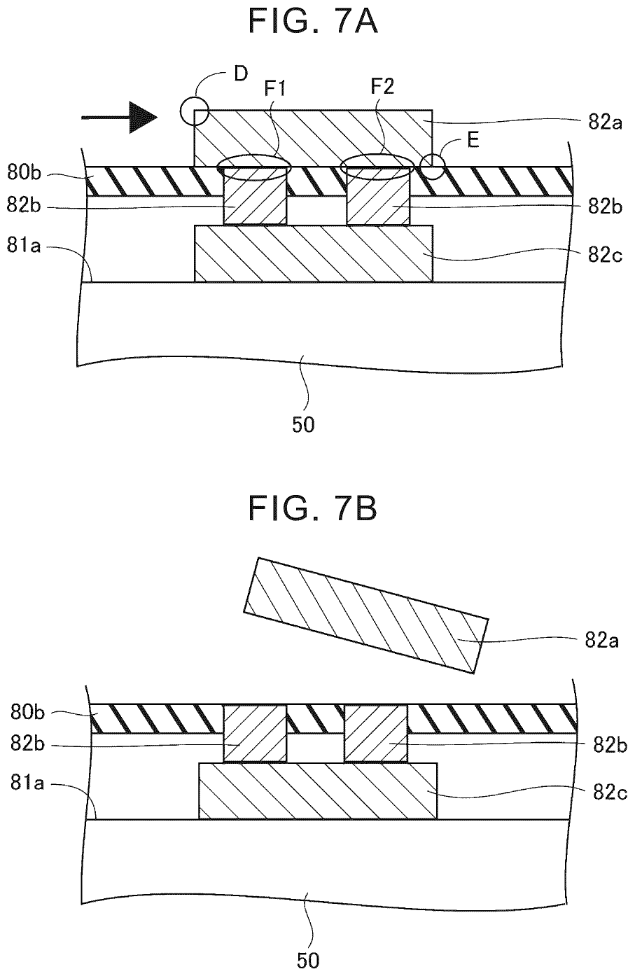

FIGS. 6A and 6B are each a schematic plan view illustrating an example of a vicinity of the electrode terminal when an external force is applied to the electrode terminal in the embodiment. FIGS. 7A and 7B are each a schematic plan view illustrating another example of a vicinity of the electrode terminal when an external force is applied to the electrode terminal in the embodiment. In FIGS. 6A and 6B, and FIGS. 7A and 7B, the cathode terminal 82 is shown. Although not shown, the same thing can happen to the anode terminal 83 as to the cathode terminal 82.

As described above, the second portion 82b has a smaller diameter than the first portion 82a and the third portion 82c. Therefore, when an external force, such as an impact, is applied to the cathode terminal 82 (first portion 82a) (arrow in FIG. 6A), the first portion 82a rotates according to the principle of a lever, since a portion where the external force acts serves as a force point (e.g., A in FIG. 6A), an end point of the first portion 82a serves as a fulcrum (e.g., B in FIG. 6A), and a contact portion between the first portion 82a and the second portion 82b serves as an action point (e.g., C in FIG. 6A). Due to the rotation, the first portion 82a is separated from the second portion 82b (FIG. 6B), thereby cutting off the conductive path within the power storage cell 1. As a result, it is expected that the occurrence of short circuits will be suppressed.

In addition, in FIGS. 7A and 7B, the cathode terminal 82 includes two second portions 82b. In the same manner as above, when an external force, such as an impact, is applied to the cathode terminal 82 (arrow in FIG. 7A), the first portion 82a rotates according to the principle of a lever, since a portion where the external force acts serves as a force point (e.g., D in FIG. 7A), an end point of the first portion 82a serves as a fulcrum (e.g., E in FIG. 7A), and contact portions between the first portion 82a and the second portion 82b serve as action points (e.g., F1 and F2 in FIG. 7A). Due to the rotation, the first portion 82a is separated from the two second portions 82b (FIG. 7B), thereby cutting off the conductive path within the power storage cell 1. As a result, it is expected that the occurrence of short circuits will be suppressed.

### Power Storage Module

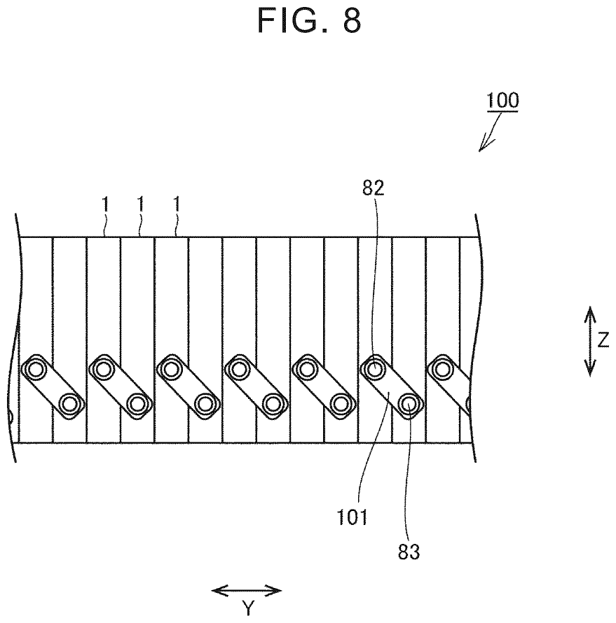

FIG. 8 is a side view illustrating an example of a power storage module in the embodiment. A power storage module 100 includes a plurality of the power storage cells 1 and busbars 101. The power storage cells 1 may be electrically series-connected or electrically parallel-connected. The number of the power storage cells 1 may be, for example, 2 or more, 4 or more, 10 or more, 20 or more, 50 or more, or 100 or more. The number of the power storage cells 1 may be, for example, 100 or less, 50 or less, 20 or less, 10 or less, or 4 or less.

The power storage cells 1 are stacked in the Y direction. Adjacent ones of the power storage cells 1 are inverted from one another in the X direction, so that the cathode terminal 82 of one of the power storage cells 1 is adjacent to the anode terminal 83 of another of the power storage cells 1.

### Busbar

The busbar 101 is electrically conductive. The busbar 101 may be made of metal, for example. The busbar 101 may contain, for example, Al, Cu, or the like. The busbar 101 connects between the electrode terminals (first portions) of adjacent ones of the power storage cells 1. The busbar 101 may connect, for example, the cathode terminal 82 and the anode terminal 83. The busbar 101 may connect, for example, the cathode terminal 82 and the cathode terminal 82. The busbar 101 may connect, for example, the anode terminal 83 and the anode terminal 83. The busbar 101 may be joined to the electrode terminal (first portion). For example, the busbar 101 may be joined to the electrode terminal (first portion) by resistance welding, ultrasonic joining, laser welding, or the like.

As shown in FIG. 8, the busbar 101 may be inclined, for example, in the Z direction. The busbar 101 may extend, for example, parallel to the Y direction.

The busbar 101 may have, for example, a plate shape. The busbar 101 may have two through holes. The electrode terminals may be inserted into the through holes.

### Others

The power storage module 100 may further include an annular member (spacer) (not shown). The annular member has electrical insulation properties. The annular member may be made of, for example, resin, ceramic, or the like. The electrode terminals may be inserted through the annular member.

The power storage module 100 may further include a sealing material (not shown). The sealing material may provide a seal between the electrode terminal and the case 80. The sealing material may be annular. The sealing material may have electrical insulation properties. The sealing material may be made of, for example, rubber, resin, or the like. The sealing material may be, for example, resistant to the electrolytic solution.

What is claimed is:

1. A power storage cell comprising:
a case; and
a power generating element, wherein
the case houses the power generating element,
the case includes a case body and a lid,
the lid is provided with an electrode terminal,
the electrode terminal includes a first portion, a second portion, and a third portion,
the first portion is located outside the case,
the third portion is located inside the case,
the second portion connects the first portion and the third portion,
the third portion is connected to the power generating element, and
the second portion has a smaller diameter than the first portion and the third portion.

2. The power storage cell according to claim 1, wherein at least a part of the second portion is located inside the case.

3. The power storage cell according to claim 1, wherein when an external force is applied to the electrode terminal, the first portion is separated from the second portion.

4. A power storage module comprising:
a plurality of the power storage cells according to claim 1; and
a busbar, wherein the busbar connects between the first portions of adjacent ones of the power storage cells.
